(19) United States
(12) Patent Application Publication
(10) Pub. No.: US 2013/0017756 A1
(43) Pub. Date: Jan. 17, 2013

(54) CLOTH STUFFED TOY AND METHOD FOR PRODUCING THE SAME

(71) Applicant: Chih-Cheng Lai, Taipei (TW)

(72) Inventor: Chih-Cheng Lai, Taipei (TW)

(21) Appl. No.: 13/184,533

(22) Filed: Jul. 16, 2011

(51) Int. Cl. A63H 3/02; B29C 65/62; B29C 67/20

(52) U.S. Cl. 446/369; 264/46.6; 156/79

(57) ABSTRACT

A cloth stuffed toy has a cloth body and a PU stuffing formed by a polyurethane foam material fully filled in and adhered to the cloth body. A method for producing the cloth stuffed toy has a cloth body preparing step, a polyurethane foam material filling step and a foaming process performing step. As the PU stuffing is securely bonded to the cloth body and is not easily fragmented, the cloth stuffed toy has advantages in providing a safety stuffed toy. Besides, in the foaming process of the polyurethane foam material, the polyurethane foam material spontaneously and extensively spreads inside the cloth body to facilitate stuffing the body effectively.

### BACKGROUND OF THE INVENTION

1. Field of the Invention

The present invention relates to a stuffed toy, especially to a cloth stuffed toy having a cloth body and a polyurethane (PU) stuffing filled in the cloth body and a method for producing the cloth stuffed toy.

2. Description of the Prior Art(s)

Stuffed toys are soft throughout, resilient and squeezable and are capable of being used as toys for pets to play, chew, and bite.

With reference to FIG. 4, a conventional stuffed toy has a body 41, a core 42 and a whistle 43. The body 41 may be formed by latex, cloth and the like. The core 42 is formed by artificial cotton fibers. The whistle 43 is embedded in the body 41. When the conventional stuffed toy is pressed or released, air is forced to flow through the whistle 43, so making a squeaking sound. The cuddly, chewable and audible conventional stuffed toys attract pets. However, when the body 41 is subjected to excessive wear and damage, cracks and holes may appear on the body 41 and the artificial cotton fibers fall out of the body 41 and are scattered around. Scattered fibers require tedious cleaning. Accordingly, the conventional stuffed toy requires further refinement.

To overcome the shortcomings, the present invention provides a cloth stuffed toy and a method for producing the cloth stuffed toy to mitigate or obviate the aforementioned problems.

### SUMMARY OF THE INVENTION

The main objective of the present invention is to provide a cloth stuffed toy and a method for producing the cloth stuffed toy. The cloth stuffed toy has a cloth body and a PU stuffing formed by a polyurethane foam material fully filled in and adhered to the cloth body. The method for producing the cloth stuffed toy has a cloth body preparing step, a polyurethane foam material filling step and a foaming process performing step.

As the PU stuffing is securely bonded to the cloth body and is not easily fragmented, the cloth stuffed toy has advantages in providing a safety stuffed toy. Besides, during the foaming process of the polyurethane foam material, the polyurethane foam material spontaneously and extensively spreads inside the cloth body to facilitate stuffing the body effectively.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a cloth stuffed toy in accordance with the present invention;

FIG. 2 is a perspective view in partial section of the cloth stuffed toy in FIG. 1;

FIG. 3 is a flow diagram of a method for producing a cloth stuffed toy in accordance with the present invention; and

FIG. 4 is a perspective view in partial section of a conventional stuffed toy in accordance with the prior art.

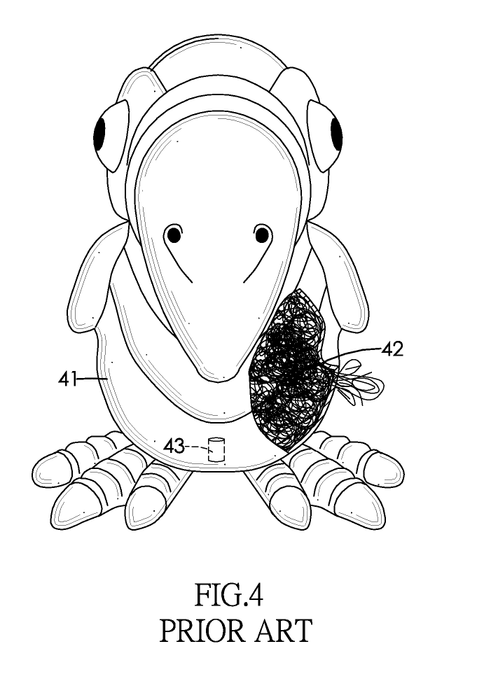

### DETAILED DESCRIPTION OF THE PREFERRED EMBODIMENTS

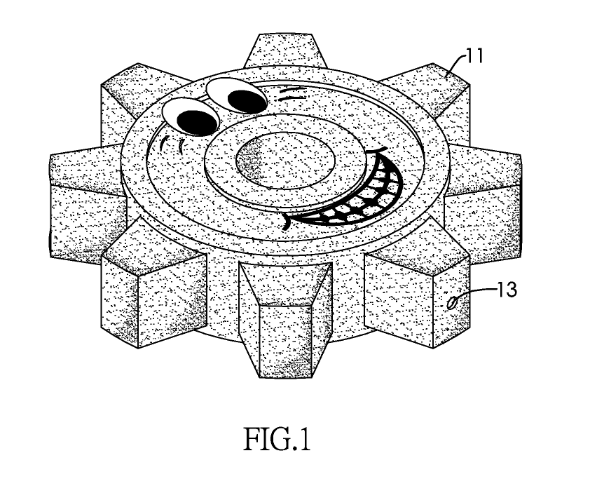

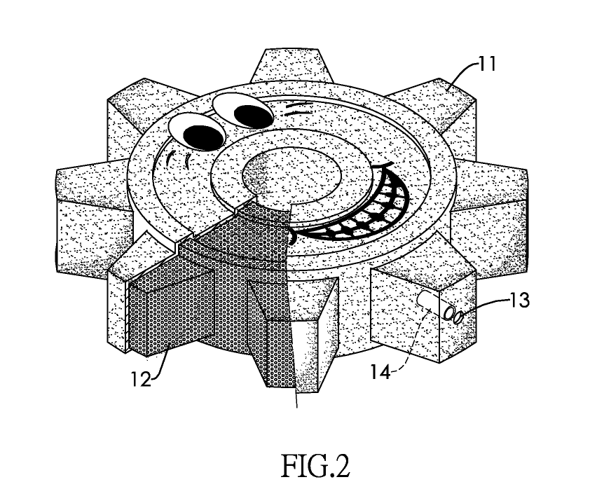

With reference to FIGS. 1 and 2, a cloth stuffed toy in accordance with the present invention comprises a cloth body 11, an injection orifice 13, polyurethane (PU) stuffing 12 and a whistle 14.

Depending upon entertaining effects to be achieved, the cloth body 11 may be formed as an animal or any shape of novelty, such as a ball, a vegetable, food or the like, is formed by attaching edges of at least one piece of cloth and has an interior chamber defined in the cloth body 11. The edges of the at least one piece of cloth that forms the cloth body 11 are attached to one another by sewing, high frequency welding or the like. In the preferred embodiment, the cloth body 11 is formed as a gear. Due to the nature of being soft and fluffy, cloth is commonly used as a material to make a harmless exterior part of a stuffed toy.

The injection orifice 13 is formed through the cloth body 11.

The PU stuffing 12 is formed by a polyurethane foam material through a foaming process in the interior chamber of the cloth body 11 and is adhered to an inner wall of the cloth body 11. The polyurethane foam material is injected through the injection orifice 13 into the interior chamber of the cloth body 11. As the PU stuffing 12 is soft and resilient together with the soft and fluffy cloth body 11, the whole cloth stuffed toy is also soft, resilient and fluffy from inside out. As the PU stuffing 12 formed by the foaming process completely fills the interior chamber of the cloth body 11 and is adhered to the inner wall of the cloth body 11, the cloth body 11 and the PU stuffing 12 are securely bonded.

The whistle 14 is mounted in the interior chamber of the cloth body 11 and corresponds to the injection orifice 13. When the cloth stuffed toy is squeezed, air inside the cloth stuffed toy is blown through the whistle 14 and the injection orifice 13 to make a sound.

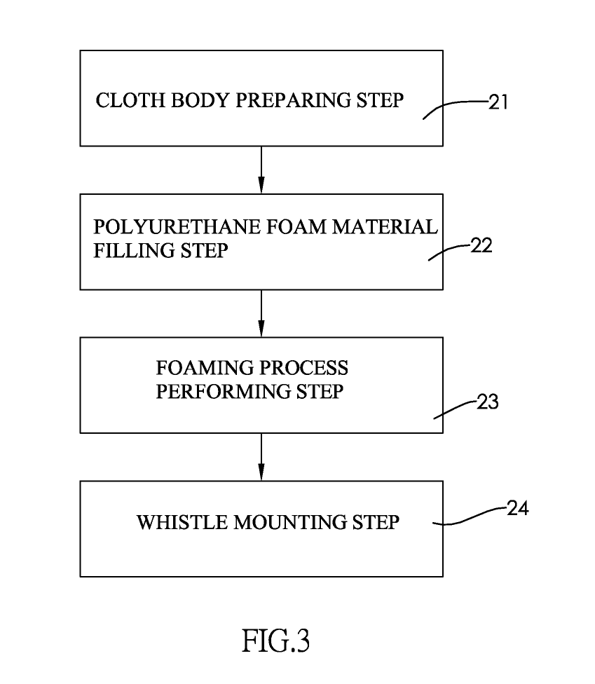

With further reference to FIG. 3, a method for producing the cloth stuffed toy in accordance with the present invention comprises steps of:

A cloth body 11 preparing step 21: preparing the cloth body 11 of the cloth stuffed toy having the interior chamber defined in the cloth body 11 and the injection orifice 13 formed through the cloth body 11;

A polyurethane foam material filling step 22: injecting the polyurethane foam material into the interior chamber through the injection orifice 13 of the cloth body 11;

A foaming process performing step 23: performing the foaming process of the polyurethane foam material until the polyurethane foam material fills the interior chamber and is adhered to the inner wall of the cloth body 11; and

A whistle mounting step 24: inserting the whistle into the interior chamber through the injection orifice 13 of the cloth body 11.

The cloth stuffed toy as described has the following advantages. The soft and fluffy cloth body 11 and the soft and resilient PU stuffing 12 do not give rise to harmful effects if bitten, chewed or played. Furthermore, unlike artificial cotton fibers, as the PU stuffing 12 is adhered to the cloth body 11, the PU stuffing 12 is not easily fragmented into small pieces that would be spread around and inhaled or eaten by people or animals. In addition to having cushioning, anti-abrasive, damping capacities and being flexible, the polyurethane foam material is a polymer with low toxicity. As a consequence, the cloth stuffed toy as described is safer than conventional stuffed toys filled with the artificial cotton fibers when bitten, chewed or played.

As for the method for producing the safety stuffed toy, during the foaming process of the polyurethane foam material, the polyurethane foam material spontaneously and extensively spreads inside the interior chamber of cloth body 11 to facilitate stuffing the cloth body 11 in an effective way.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A cloth stuffed toy comprising:
a cloth body having an interior chamber defined in the cloth body; and
a PU stuffing formed by a polyurethane foam material through a foaming process in the interior chamber of the cloth body and adhered to an inner wall of the cloth body.

2. The cloth stuffed toy as claimed in claim 1 further comprising:
an injection orifice formed through the cloth body; and
a whistle mounted in the interior chamber of the cloth body and corresponding to the injection orifice.

3. A method for producing a cloth stuffed toy, comprising steps of:
preparing a cloth body of the cloth stuffed toy having an interior chamber defined in the cloth body and an injection orifice formed through the cloth body;
injecting a polyurethane foam material into the interior chamber through the injection orifice of the cloth body; and
performing a foaming process of the polyurethane foam material until the polyurethane foam material fills the interior chamber and is adhered to the inner wall of the cloth body.

4. The method for producing the cloth stuffed toy as claimed in claim 3 further comprising a step of inserting a whistle into the interior chamber through the injection orifice of the cloth body.

5. The method for producing the cloth stuffed toy as claimed in claim 3, wherein the cloth body is formed by attaching edges of at least one piece of cloth.

6. The method for producing the cloth stuffed toy as claimed in claim 4, wherein the cloth body 11 is formed by attaching edges of at least one piece of cloth.

7. The method for producing the cloth stuffed toy as claimed in claim 5, wherein the edges of the at least one piece of cloth that forms the cloth body are attached to one another by sewing.

8. The method for producing the cloth stuffed toy as claimed in claim 6, wherein the edges of the at least one piece of cloth that forms the cloth body are attached to one another by sewing.

9. The method for producing the cloth stuffed toy as claimed in claim 5, wherein the edges of the at least one piece of cloth that forms the cloth body are attached to one another by high frequency welding.

10. The method for producing the cloth stuffed toy as claimed in claim 6, wherein the edges of the at least one piece of cloth that forms the cloth body are attached to one another by high frequency welding.
